(19) United States
(12) Patent Application Publication
(10) Pub. No.: US 2025/0367941 A1
(43) Pub. Date: Dec. 4, 2025

(54) DATA GENERATION APPARATUS, PRINTING APPARATUS, CONTROL METHOD, AND STORAGE MEDIUM

(71) Applicant: CANON KABUSHIKI KAISHA, Tokyo (JP)

(72) Inventors: FUMITAKA GOTO, Tokyo (JP); TOMOKAZU ISHIKAWA, Kanagawa (JP); YUTA IKESHIMA, Kanagawa (JP); TAKAHISA AKAISHI, Kanagawa (JP)

(21) Appl. No.: 19/224,280

(22) Filed: May 30, 2025

(30) Foreign Application Priority Data
Jun. 4, 2024 (JP) 2024-090679

(51) Int. Cl. B41J 3/32; B41J 11/00; G06K 15/02; G06K 15/10

(52) U.S. Cl. CPC B41J 3/32; B41J 11/002; G06K 15/102; G06K 15/1873

(57) ABSTRACT

A data generation apparatus is provided that generates pixel data for printing a 2.5-dimensional image and has: a conversion unit configured to convert the 2.5-dimensional data having a first resolution to pixel data having a second resolution by use of position information on a 2.5-dimensional region obtained from 2.5-dimensional data representing the 2.5-dimensional image; and an adjustment unit configured to adjust tone values of second-resolution pixels included in the 2.5-dimensional region represented in the pixel data by determining a tone value of a pixel in a center region including at least a center pixel and a tone value of a pixel in a marginal region which is inside of the 2.5-dimensional region and surrounding the center region using information on height characteristics at pixel positions of the second-resolution pixels.

### BACKGROUND

### Technical Field

The present disclosure relates to a data generation apparatus, a printing apparatus, a control method, and a storage medium, or specifically to a Braille printing technique.

### Description of the Related Art

Print media having a foaming layer that foams under heat are known, and a three-dimensional image formation system is known which forms a three-dimensional image by causing foam formation at a predetermined region on such a print medium. A three-dimensional image formation system prints a corresponding grayscale image to cause foam formation at a predetermined region (e.g., a Braille dot region where a Braille dot is to be formed). The density of the grayscale image corresponds to the height of foam. A three-dimensional image formation system forms a Braille image by controlling the image density of a grayscale image to print predetermined Braille dot regions with a predetermined uniform foam height.

Japanese Patent Laid-Open No. 2021-108128 discloses a technique where a density adjustment region for density adjustment is set at a region outside of and surrounding a Braille dot region (referred to as an outer peripheral region) to separately control the foam height in the Braille dot region and the foam height in the Braille outer region.

A Braille dot formed with the method of Japanese Patent Laid-Open No. 2021-108128 has a uniform cross-sectional height. However, a typical Braille dot has a cross-sectional shape protruding upward in a rounded manner, i.e., the cross-sectional height is lower in a region inside of a Braille dot region and surrounding the center of the Braille dot region (referred to as a peripheral inner region) than at the center of the Braille dot region. Also, a Braille dot formed with the method of Japanese Patent Laid-Open No. 2021-108128 has a larger diameter than normal due to the setting of the density adjustment region.

According to the paper titled “Study on the Distinguishable Braille Shape” (HAYASHI Mieko, KAMODA Marisa, and FUJIMOTO Hiroshi: The Japanese Journal of Ergonomics Vol. 39, No. 3, 117 to 122, 2003), the cross-sectional shape of Braille dots contributes to a meaningful difference in legibility, and ball-shaped dots tend to offer higher legibility to experienced Braille readers. Thus, a sensation felt upon touching Braille dots with a uniform cross-section height may be different from that felt upon touching typical Braille dots; thus, Braille dots with a uniform cross-section height may lower Braille illegibility.

### SUMMARY

Thus, in view of the above problem, the present disclosure aims to form Braille dots with a shape that are more legible and can be read more easily.

An embodiment of the present disclosure is a data generation apparatus that generates pixel data for printing a 2.5-dimensional image, the data generation apparatus including: a conversion unit configured to, by use of position information on a 2.5-dimensional region obtained from 2.5-dimensional data representing the 2.5-dimensional image, convert the 2.5-dimensional data having a first resolution to pixel data having a second resolution; and an adjustment unit configured to adjust tone values of second-resolution pixels included in the 2.5-dimensional region represented in the pixel data by determining a tone value of a pixel in a center region of the 2.5-dimensional region including at least a center pixel and a tone value of a pixel in a marginal region which is inside of the 2.5-dimensional region and surrounding the center region, using information on height characteristics at pixel positions of the second-resolution pixels.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating the configuration of a printing apparatus;

FIG. 2 is a diagram illustrating the configuration of a printing system;

FIGS. 3A and 3B are diagrams illustrating the configuration of a printhead;

FIG. 4 is a diagram illustrating a print medium used for formation of a three-dimensional image;

FIG. 5 is a diagram showing the relation between the application amount of a foaming-promotion-component-containing ink and foam height;

FIGS. 6A and 6B are diagrams showing a cross-sectional shape of a Braille dot;

FIG. 7 is a functional block diagram illustrating data processing on Braille data;

FIGS. 8A and 8B are diagrams illustrating resolution conversion on a Braille dot;

FIGS. 9A and 9B are diagrams illustrating the relation between foam heights and tone values within a Braille dot according to a first embodiment;

FIG. 10 is a functional block diagram illustrating image processing executed in printing a color image;

FIG. 11 is a flowchart of processing according to the first embodiment;

FIGS. 12A and 12B are diagrams illustrating the relation between foam heights and tone values within a Braille dot according to a second embodiment; and

FIGS. 13A, 13B, 13C, and 13D are diagrams illustrating how ink dots spread according to a third embodiment.

### DESCRIPTION OF THE EMBODIMENTS

Preferred embodiments of the present disclosure are described in specific and detailed terms below with reference to the drawings attached hereto. Note that the embodiments below are provided with no intention of limiting the disclosure according to the scope of claims more than necessary. Also, while a plurality of features are described in the embodiments below, not all those features are necessarily essential to the problem solutions provided by the disclosure, and some or all of those features may be combined in any way. Further, throughout the drawings attached hereto, the same or like configurations are denoted by common reference numerals, and repeated descriptions are basically omitted.

### <Configuration of a Printing Apparatus>

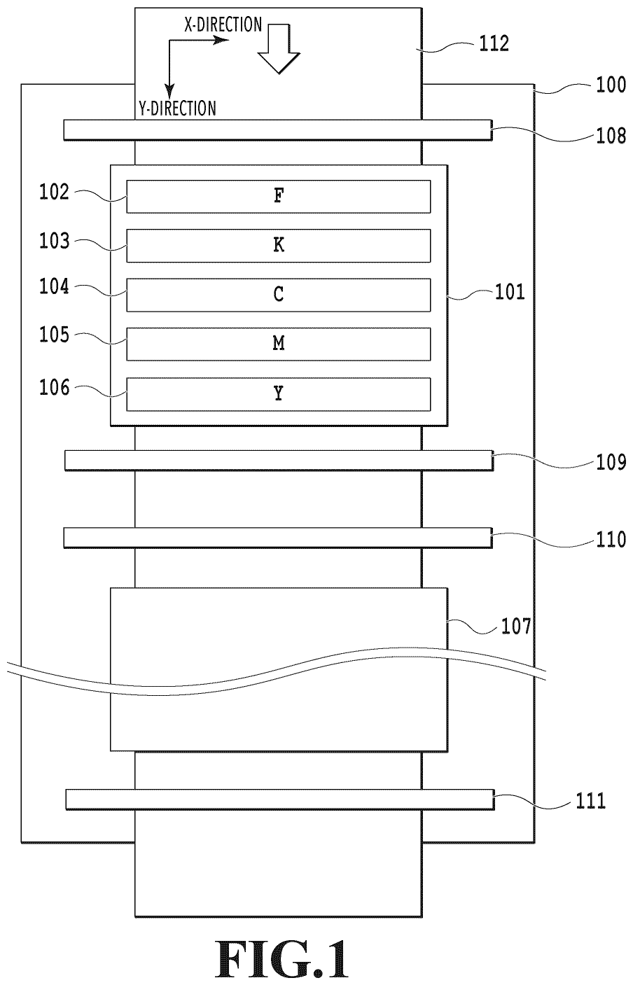

FIG. 1 is a schematic diagram showing the configuration of a printing apparatus 100 according to the present disclosure.

Conveyance rollers 108, 109, 110, and 111 each form a pair with a conveyance roller (not shown) to sandwich a print medium 112 and convey the print medium 112 in a Y-direction in FIG. 1.

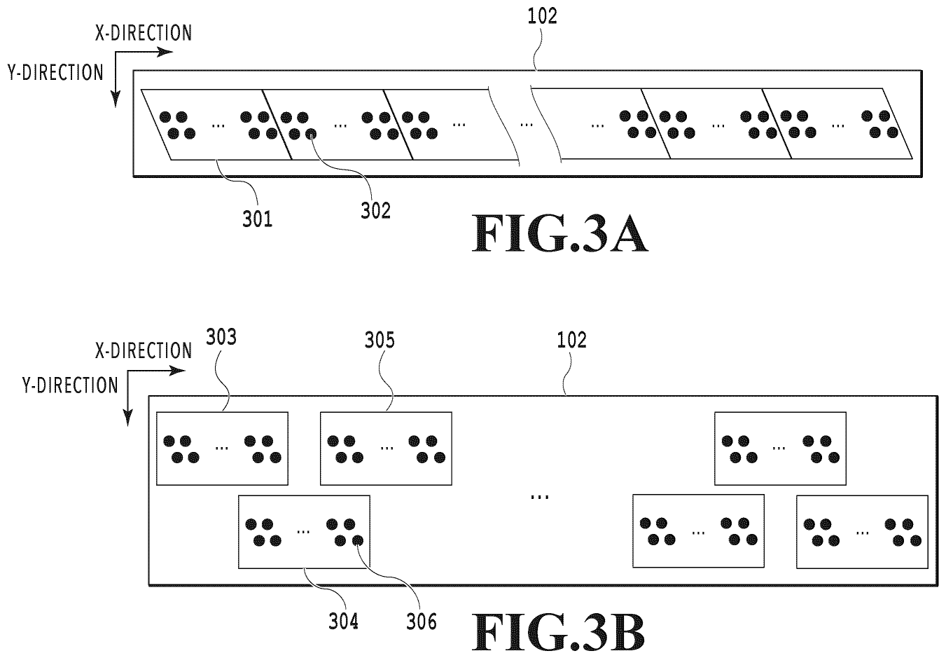

A print unit 101 employs the inkjet (IJ) method and ejects and applies ink to the print medium 112 conveyed in the Y-direction. A printhead 102 ejects a foaming-control-component-containing ink (expressed as F). A printhead 103 ejects a black ink (expressed as K). A printhead 104 ejects a cyan ink (expressed as C). A printhead 105 ejects a magenta ink (expressed as M). A printhead 106 ejects a yellow ink (expressed as Y). Each printhead extends in an X-direction orthogonal to the Y-direction and includes nozzle arrays of ink-ejecting nozzles, each nozzle array having a plurality of nozzles arrayed in the X-direction (see FIGS. 3A and 3B). Also, in the present disclosure, the print heads are arranged in the order of the printheads 102, 103, 104, 105, and 106 in the Y-direction, and the inks are printed on the print medium 112 in the order of F, K, C, M, and Y. Note that the inks K, C, M, and Y are collectively called a color ink (a color material).

A heating unit 107 heats the print medium 112 and inks applied to the print medium 112. In a case where the print medium 112 is one containing foaming particles that foam under heat, the heat applied by the heating unit 107 causes foam formation at a region to which the foaming-control-component-containing ink has been applied. A mechanism of foaming by the foaming-control-component-containing ink or the like will be described in detail later. Also, the color inks applied to the print medium 112 are dried and fixated by the heat applied by the heating unit 107, irrespective of the type of the print medium 112.

### <Configuration of a Printing System>

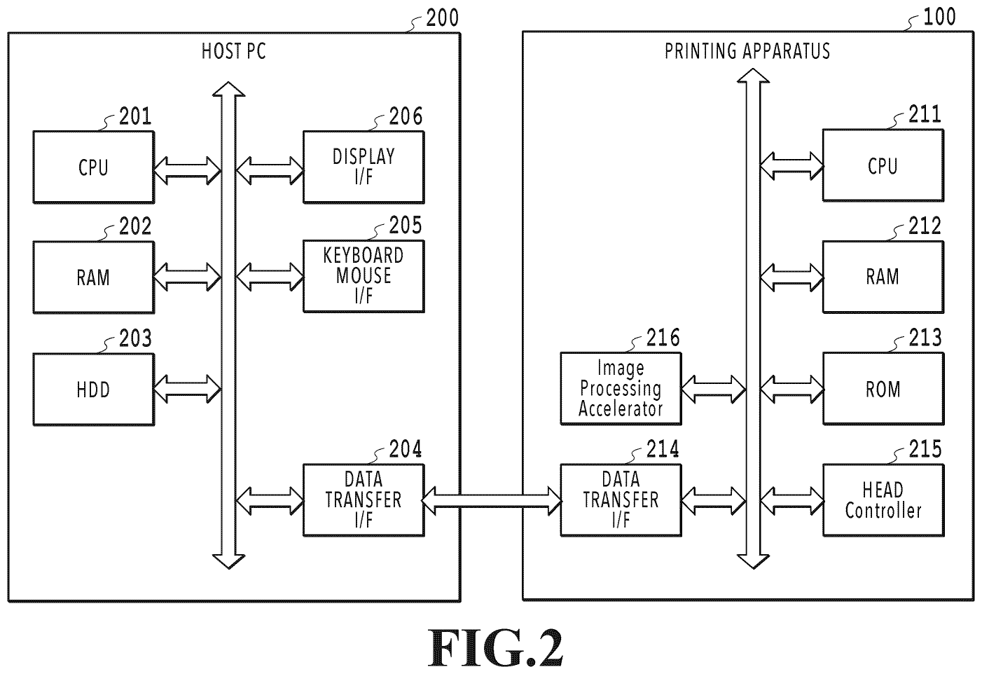

FIG. 2 is a block diagram showing a hardware configuration of a printing system formed by the printing apparatus 100 shown in FIG. 1 and a host apparatus connected to the printing apparatus 100. As shown in FIG. 2, this printing system is formed by the printing apparatus 100 shown in FIG. 1 and a personal computer (hereinafter referred to as a host PC) 200 functioning as a host apparatus for the printing apparatus 100.

The host PC 200 includes a CPU 201, a RAM 202, an HDD 203, a data transfer interface (I/F) 204, a keyboard/mouse (registered trademark) I/F 205, and a display I/F 206.

The CPU 201 executes predetermined processing according to a program stored in the HDD 203 or the RAM 202. The RAM 202 is a volatile storage and stores programs and data temporarily. Also, the HDD 203 is a non-volatile storage and stores programs and data, like the RAM 202. The data transfer I/F 204 controls transmission and reception of data to and from the printing apparatus 100. A data transfer method usable for this data transmission and reception is wired connection such as USB, IEEE1394, or LAN or wireless connection such as Bluetooth (registered trademark) or WiFi. The keyboard/mouse (registered trademark) I/F 205 is an interface for controlling a user interface (UI) such as a keyboard or a mouse, and a user can input information to the host PC 200 through this. The display I/F 206 controls what is displayed on a display (not shown).

Meanwhile, the printing apparatus 100 includes a CPU 211, a RAM 212, a ROM 213, a data transfer I/F 214, a head controller 215, and an image processing accelerator 216.

The CPU 211 executes processing in the embodiments to be described later according to programs stored in the ROM 213 or the RAM 212. The RAM 212 is a volatile storage and stores programs and data temporarily. Also, the ROM 213 is a non-volatile storage and stores programs and table data to be used for the processing in the embodiments to be described later. Also, the data transfer I/F 214 controls transmission and reception of data to and from the host PC 200.

The head controller 215 controls print operations of the print heads 102 to 106 based on print data. Specifically, the head controller 215 is configured to read control parameters and print data from a predetermined address in the RAM 212. More specifically, once the CPU 211 writes control parameters and print data to a predetermined address in the RAM 212, the head controller 215 starts processing, causing the print heads to execute print operations.

The image processing accelerator 216 is configured by hardware and is capable of faster image processing than the CPU 211. Specifically, the image processing accelerator 216 is configured to read parameters and data necessary for image processing from a predetermined address in the RAM 212. Then, once the CPU 211 writes the parameters and data to the predetermined address in the RAM 212, the image processing accelerator 216 is activated, and predetermined image processing is executed.

Note that the image processing accelerator 216 is not necessarily an essential component, and the predetermined image processing may be executed only by processing performed by the CPU 211, depending on, e.g., the specifications of the printing apparatus.

### <Configuration of the Printheads>

FIGS. 3A and 3B are schematic diagrams showing the configuration of the printhead 102. Specifically, FIG. 3A is a plan view showing the printhead 102 according to the present disclosure. The printhead 102 includes a plurality of print chips 301, with each of the print chip 301 including a plurality of nozzles 302. The print chip 301 includes a circuit that drives, e.g., heater elements and piezoelectric elements in order to eject the ink from the nozzles 302. The nozzles on each print chip are configured and arranged as follows. Specifically, each print chip has a set of two nozzle arrays arranged in the Y-direction, with each of the two arrays having a plurality of nozzles arranged in the X-direction at a pitch of 600 dpi. Also, the two nozzle arrays are arranged so that their respective nozzles are offset from each other in the X-direction at 1200 dpi. Further, each print chip has three sets (not shown) of the two arrays arranged in the Y-direction, the three sets being arranged in the Y-direction. Also, as shown in FIG. 3A, the plurality of print chips are arranged in the X-direction, with nozzles in the same row on adjacent print chips being arranged at a pitch of 600 dpi. Each of the nozzle arrays arranged on each print chip is formed of 600 nozzles arranged in the X-direction. In other words, a single print chip has a print width which is one inch long in the X-direction. Note that one inch=approximately 25.4 mm.

The nozzles 302 eject and apply the foaming-control-component-containing ink using the IJ method to the print medium 112, thereby printing an image on the print medium 112. The printhead 102 according to the present disclosure has 13 print chips 301 in the X-direction and therefore can print an image which is 13 inches (approximately 330 mm) wide in the X-direction on the print medium 112. The print resolution in the X-direction is 1200 dpi, and the print resolution in the Y-direction is also 1200 dpi. An ejection frequency for each nozzle 302 (the number of times each nozzle 302 can eject ink in one second) is controlled to be 10 KHz, and the print medium 112 is conveyed in the Y-direction approximately 8.33 inches per second. The print resolution in the Y-direction can thus be controlled to be 1200 dpi. As described above, each print chip has sets of two nozzle arrays which are located at different positions from each other in the Y-direction, and the nozzles in one of the nozzle arrays are offset from the nozzles in the other nozzle array in the X-direction by 1200 dpi. The nozzles 302 in each array are arrayed in the X-direction at a pitch of 600 dpi. Having three sets of such a pair of nozzle arrays in the Y-direction, a print chip can apply up to three shots of ink to the same pixel in the Y-direction. The printheads 103, 104, 105, and 106 have the same configuration as the printhead 102 in FIG. 3A just described. Each printhead applies 2 μl of ink (F, K, C, M, or Y) per shot to the print medium 112. Also, the inks F, K, C, M, and Y are adjusted to weigh 2 ng per 2 pl. Because up to three shots of each ink can be applied to the same pixel at 1200 dpi, a maximum of 6 pl, i.e., 6 ng, of the ink can be applied to the same pixel.

FIG. 3B is a plan view showing another configuration of the printhead 102 according to the present disclosure, different from that in FIG. 3A. The printhead 102 includes a print chip 303, a print chip 304 located at a different position from the print chip 303 in the Y-direction, and a print chip 305 located at a different position from the print chip 303 in the X-direction and at the same position as the print chip 303 in the Y-direction. Each of the print chips 303 to 305 includes a plurality of nozzles 306. The nozzles 306 in each print chip are configured as follows. Specifically, each print chip has a set of two nozzle arrays arranged in the Y-direction, with each of the two arrays having a plurality of nozzles arranged in the X-direction at a pitch of 600 dpi. Also, the nozzles in one of the arrays and the nozzles in the other one are offset from each other in the X-direction by 1200 dpi. The print chip 304 is offset from the print chip 303 in the Y-direction, and the print chip 305 is offset from the print chip 303 in the X-direction. The print chip 303 and the print chip 304 are arranged so that the rightmost two pixels×the two arrays on the print chip 303 overlap with the leftmost two pixels×the two arrays on the print chip 304 in the X-direction. Note that the print chip 304 is disposed offset in the +Y-direction so as not to physically overlap with the print chip 303.

Also, the print chip 304 and the print chip 305 are arranged so that the rightmost two pixels×the two arrays on the print chip 304 overlap with the leftmost two pixels×the two arrays on the print chip 305 in the X-direction. Note that the print chip 305 is disposed offset in the −Y-direction so as not to physically overlap with the print chip 304.

After that, the combination of the arrangement of the print chip 304 relative to the print chip 303 and the arrangement of the print chip 305 relative to the print chip 304 is repeated, forming the arrangement shown in FIG. 3B. The nozzles 306 overlapping in the X-direction eject the ink at ejection frequencies dispersed therebetween at a predetermined ratio so as not to apply too much ink to the same region on the print medium 112.

Although nozzles on print chips adjacent to each other in the X-direction do not overlap in the X-direction in FIG. 3A described above, it is to be noted that they may be configured to overlap. In that case, overlapping nozzles need to eject ink at ejection frequencies dispersed therebetween at a predetermined ratio so as not to apply ink to the same region on the print medium 112.

### <Print Medium Having a Foaming Layer>

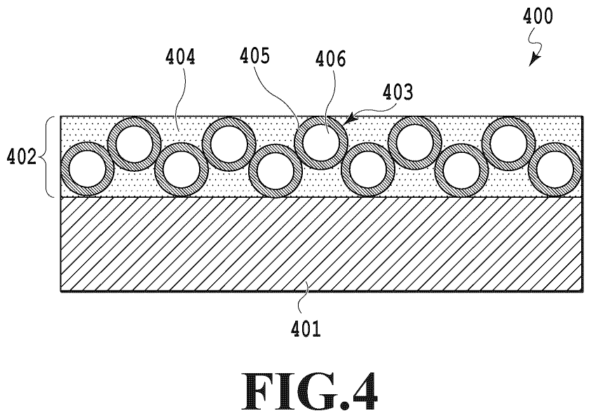

FIG. 4 is a schematic sectional view of an example print medium used for three-dimensional image formation according to the present disclosure. As shown in FIG. 4, a print medium 400 has a base material 401 and a foaming layer 402 provided on the base material 401. The foaming layer 402 contains foaming particles 403 that foam under heat.

The base material 401 functions as a support body for supporting the foaming layer 402. There is no particular limitation as to the type of the base material 401. Examples of the base material 401 include regular paper made of natural pulp, kenaf paper, and plastic film sheets of polypropylene, polyethylene, polyester, or the like. Other examples include what is called synthetic paper, nonwoven cloth, or the like made of synthetic fibers, synthetic pulp, or synthetic resin film and made to look like paper.

As shown in FIG. 4, the foaming layer 402 is a layer provided on at least one of the surfaces of the base material 401 and containing the foaming particles 403 and a binder resin 404. The foaming particles 403 are each a microcapsule that foams under heat and has a capsule-shaped shell layer 405 containing a thermoplastic resin and a volatile material 406 sealed in the shell layer 405. Upon application of heat to the foaming particle 403, the thermoplastic resin forming the shell layer 405 softens, while the volatile material 406 sealed in the shell layer 405 gasifies and increases in volume. As a result, the foaming particle 403 foams like a balloon.

Examples of the thermoplastic resin contained in the shell layer include polystyrene, styrene-acrylic acid ester copolymer, polyamide resin, polyacrylic acid ester, polyvinylidene chloride, polyacrylonitrile, and polymethylmethacrylate. Other examples include vinylidene chloride-acrylonitrile, methacrylic acid ester-acrylic acid copolymer, vinylidene chloride-acrylic acid copolymer, and vinylidene chloride-acrylic acid ester copolymer.

Examples of the volatile material include low-molecular-weight hydrocarbons such as ethane, ethylene, propane, propene, n-butane, isobutane, n-pentane, isopentane, neopentane, n-hexane, heptane, and petroleum ether. Other examples include chlorofluorocarbons such as CCl3F, CCl2F2, CClF3, and CClF2-CClF2. More examples include tetraalkylsilane such as tetramethylsilane, trimethylethylsilane, trimethylisopropylsilane, and trimethyl-n-propylsilane. It is preferable that the volatile material be a hydrocarbon with a molecular weight of 120 or below. Also, although there is no particular limitation as to the lower limit of the molecular weight of the volatile material (hydrocarbon), it is preferable that the molecular weight be, for example, 50 or larger. A content of the foaming particles in the foaming layer is preferably 5% by mass or higher and 95% by mass or lower relative to the entire mass of the foaming layer.

The foaming layer 402 contains the binder resin 404 in order to have higher adhesiveness to the base material 401. The binder resin plays an important role in reducing peeling of the foaming layer from the base material in the event where the foaming particles in the foaming layer foam under heat. A water-insoluble resin is used as the binder resin. By containing a water-insoluble resin, the binder resin is harder to dissolve in the water contained in foaming promotion liquid, making it less likely for the foaming promotion liquid to lower the adhesiveness between the foaming layer and the base material. Further, for a similar reason, even in a case where water-based ink containing water is applied to a print medium, the adhesiveness between the foaming layer and the base material is less likely to lower.

The water-insoluble resin herein refers to a resin that remains by 95% by mass or more after being immersed in 80° C. warm water for two hours. The water-insoluble resin is preferably at least one selected from the group consisting of acrylic resins and urethane resins. It is more preferable that the water-insoluble resin be at least one selected from the group consisting of acrylic resins without an ester group and urethane resins without an ester group. Then, it is preferable that the water-insoluble resin be a non-water-absorbable resin. A content of the water-insoluble resin in the foaming layer is preferably 10% by mass or higher and 95% by mass or lower relative to the entire mass of the foaming layer. Also, the foaming layer may contain water-soluble resin along with the water-insoluble resin, as long as the advantageous effects of the present disclosure can be obtained. Also, the binder resin preferably has a glass transition temperature of −10° C. or higher and 30° C. or lower. By having a glass transition temperature within the above range, the binder resin is less likely to hinder foaming of the foaming particles.

The mass ratio of the foaming particles and the binder resin is preferably as follows: the foaming particles:the binder resin=5:95 to 90:10. With the mass ratio of the foaming particles and the binder resin being within the above range, not only foamability of the foaming particles, but also adhesiveness to the base material provided by the binder resin can be improved. The foaming layer may further contain a component such as a pigment, an antioxidant, a dye, a surfactant, and the like, as long as its foamability is not compromised.

### <Foaming-Control-Component-Containing Ink>

In the present disclosure, as described earlier, a foaming-control-component-containing ink is applied to the print medium 112. The foaming-control-component-containing ink is used as a foaming promotion liquid for three-dimensional image formation.

The foaming promotion liquid contains a foaming promotion component for lowering the temperature at which the foaming particles 403 start foaming. Applying the foaming promotion liquid containing a foaming promotion component to the foaming layer of a print medium using a method such as inkjet ejection or coating can soften the thermoplastic resin contained in the shell layer 405 in the foaming particles 403. As a result, it is estimated that the foaming start temperature and the maximum foaming temperature for the foaming particles 403 can be shifted to the lower temperature side.

The foaming promotion component is any component which is capable of softening the thermoplastic resin contained in the shell layer 405 of the foaming particles 403 and which is a compound without a hydroxyl group. An appropriate component can be selected according to, e.g., the type of the thermoplastic resin. Examples of the foaming promotion component include 2-pyrrolidone, dimethyl sulfoxide, N, N-dimethylformamide, and N-methyl-2-pyrrolidone. It is preferable that the compound without a hydroxyl group, as the foaming promotion component, have a boiling point higher than the temperature for heating the foaming layer 402. In a case where the compound has a boiling point higher than the temperature for heating the foaming layer 402, the compound is unlikely to gasify while the foaming layer 402 is heated, which contributes to softening of the thermoplastic resin in the shell layer 405 of the foaming particles 403. A content of the compound without a hydroxyl group, as the foaming promotion component, is preferably 10% by mass or higher and 70% by mass or lower relative to the entire mass of the foaming promotion liquid.

It is preferable that the absolute value of the difference between a solubility parameter (SP1) of the thermoplastic resin forming the shell layer 405 of the foaming particles (microcapsules) 403 and a solubility parameter (SP2) of the foaming promotion component (|SP1−SP2|) be 3.5 or smaller. With the absolute value of the difference between the solubility parameters being within the numerical range described above, foamability can be improved for the region on the foaming layer 402 to which the foaming promotion liquid containing the foaming promotion component is applied.

Also, it is preferable that the absolute value of the difference between a Hansen solubility parameter (HSP1) of the thermoplastic resin forming the shell layer 405 of the foaming particles (microcapsules) 403 and a Hansen solubility parameter (HSP2) of the foaming promotion component (|HSP1−HSP2|) be 20 or smaller. With the absolute value of the difference between the Hansen solubility parameters being within the numerical range described above, foamability can be improved for the region on the foaming layer 402 to which the foaming promotion liquid containing the foaming promotion component is applied.

The solubility parameters (SP values) of the thermoplastic resin forming the shell layer 405 and the foaming promotion component are both a value derived (calculated) by computation. Also, the Hansen solubility parameters (HSP values) of the thermoplastic resin forming the shell layer and the foaming promotion component are both an actual measured value measured and derived (calculated) using the dynamic light scattering method.

In a case where the foaming promotion component is liquid at ordinary temperature (25° C.), the foaming promotion component itself may be used as the foaming promotion liquid. Also, the foaming promotion liquid may further contain a component other than the foaming promotion component (other components). For example, in order to have improved ejection stability, the foaming promotion liquid preferably further contains a liquid component such as a solvent. As the solvent, water or any of various water-soluble organic solvents can be used. Deionized water (ion-exchanged water) is preferably used as the water. Examples of the water-soluble organic solvent include alcohols, glycols, glycol ethers, and nitrogen-containing compounds.

Examples of a component other than the liquid component include water-soluble organic compounds which are solid at a temperature of 25° C., such as urea and derivatives thereof, trimethylol propane, and trimethylol ethane. Further, as needed, the foaming promotion liquid may contain various additives such as a pH adjuster, a defoamer, an antirust, an antiseptic, a mold preventative, an antioxidant, an anti-reducing agent, and a chelator.

### <Control of Foam Height>

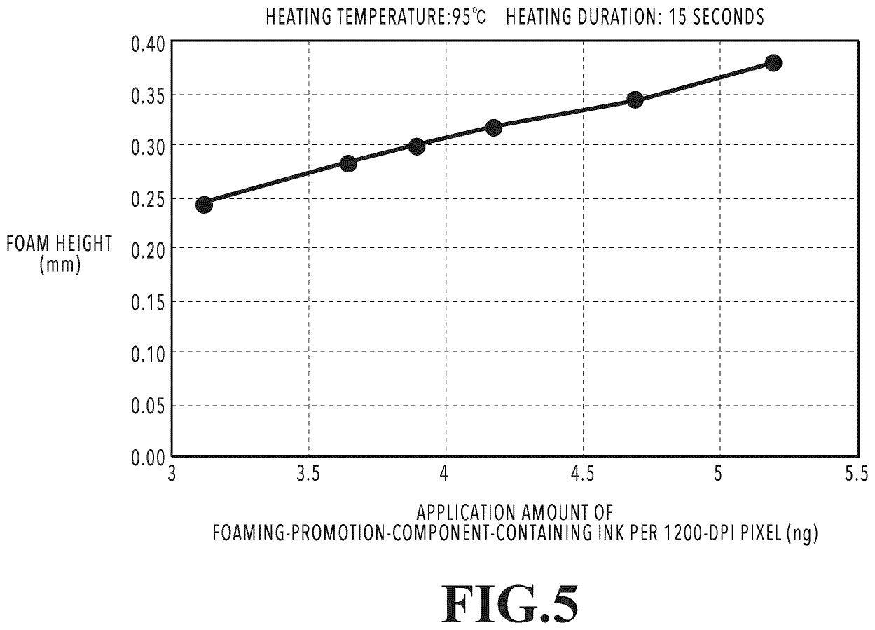

FIG. 5 is a diagram showing the relation between foam height and the amount of the above-described foaming-control-component-containing ink applied to a print medium having the above-described foaming layer. Note that in the graph in FIG. 5, the horizontal axis represents the application amount of the foaming-control-component-containing ink, or specifically the application amount thereof per 1200-dpi pixel, and the vertical axis represents foam height, or more specifically, the height of foam formed in the event where a 1200-dpi pixel is heated by the heating unit 107 at a heating temperature of 95° C. and for a heating duration of 15 seconds. As shown in FIG. 5, the foam height of the print medium having the foaming layer can be controlled by the application amount of the foaming-control-component-containing ink.

### <Typical Braille Dot Formed by a Braille Printer>

Typically, formation of Braille dots is achieved by a Braille editor that generates Braille data and by a Braille printer that performs printing based on the Braille data generated by the Braille editor.

Multi Braille Document Editor (MBDE) by Nippon Telesoft, Co., Ltd and EDEL by FUJINO Toshihiro are known as specific examples of a Braille editor. DO-Multi Super and DOG-Basic32 Braille printers are known as specific examples of a Braille printer. A Braille printer forms Braille characters on paper by pressing an embosser (a Braille embosser means) against the paper. One embossment by a Braille printer forms a single Braille dot. Like the Braille printer, the Braille editor, for example EDEL, describes a single Braille dot as a single object and expresses a protrusion as a black dot, as described in Japanese Patent Laid-Open No. 2021-108128. Thus, EDEL does not take into consideration that a single Braille dot is represented using a plurality of pixels (each having a pixel value).

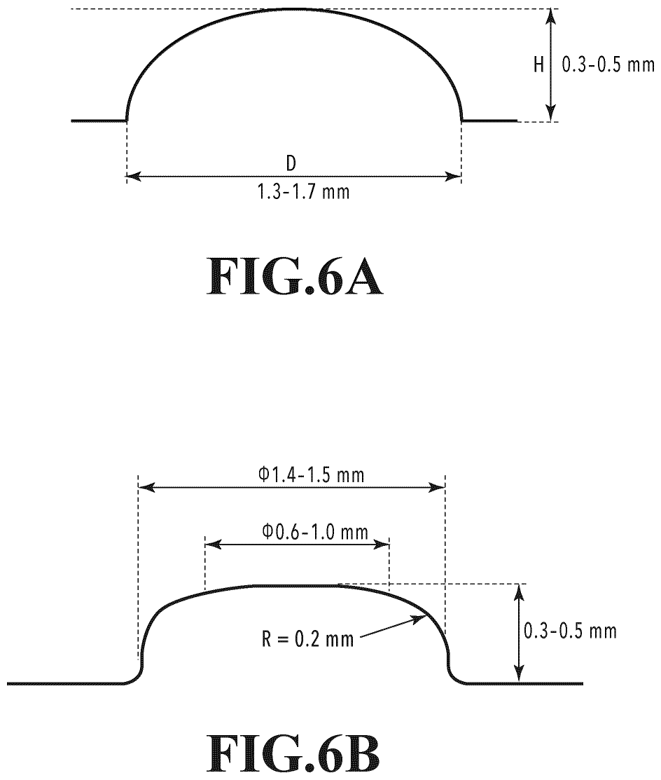

FIG. 6A shows a cross-sectional shape of a Braille dot according to JIS T0921 standards. FIG. 6B shows a cross-sectional shape of a typical Braille dot available online (https://web.econ.keio.ac.jp/staff/nakanoy/article/braille/BR/chap3/3-2/3-2.html by KIZUKA Yasuhiro from National Institute of Special Needs Education).

As shown in FIGS. 6A and 6B, a standardized Braille dot and a typical Braille dot are both not rectangular in cross-sectional shape. In a comparison between the cross-sectional shape of a center region of a region forming a Braille dot (referred to as a Braille dot region) and the cross-sectional shape of a peripheral region inside of the Braille dot region and surrounding the center region, the latter is lower than the former, and the former and the latter both form a rounded upwardly protruding shape. The rounded cross-sectional shape shown in FIG. 6B is slightly flatter than the rounded cross-sectional shape shown in FIG. 6A. Also, regarding the standardized Braille dot shown in FIG. 6A, a region inside the Braille dot region (referred to as an inner region) is 1.3 mm to 1.7 mm in width, and the center region is 0.3 mm to 0.5 mm in height. Meanwhile, regarding the typical Braille dot shown in FIG. 6B, the inner region is 1.4 mm to 1.5 mm in width, and the center region is 0.6 mm to 1.0 mm in width and 0.3 mm to 0.5 mm in height.

### <Data Processing Performed in Forming Braille Dots Using an IJ Printer>

The following describes data processing performed in a case where the inkjet printer according to the present disclosure forms Braille dots by applying the above-described foaming-promotion-component-containing ink to a print medium having the above-described foaming layer.

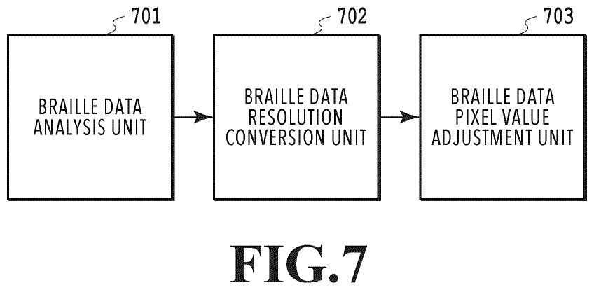

FIG. 7 is a functional block diagram illustrating data processing on Braille data according to the present disclosure. A series of processes performed on Braille data necessary for an inkjet printer to form Braille are executed by a Braille data analysis unit 701, a Braille data resolution conversion unit 702, and a Braille data pixel value adjustment unit 703.

The Braille data analysis unit 701, the Braille data resolution conversion unit 702, and the Braille data pixel value adjustment unit 703 are implemented by the host PC 200. Specifically, the CPU 201 of the host PC 200 functions as the Braille data analysis unit 701, the Braille data resolution conversion unit 702, and the Braille data pixel value adjustment unit 703. More specifically, the CPU 201 implements the Braille data analysis unit 701, the Braille data resolution conversion unit 702, and the Braille data pixel value adjustment unit 703 by loading programs stored in the HDD 203 or the ROM (not shown) to the RAM 202 and executing them.

The Braille data analysis unit 701 receives Braille data generated by a Braille editor as described above and analyzes the received Braille data. Braille data is image data for rendering a 2.5-dimensional image. A 2.5-dimensional object is an object formed with height on a flat surface like the print medium 112, like a Braille dot (see FIGS. 6A and 6B). Note that image data on a 2.5-dimensional object is referred to as 2.5-dimensional data.

Based on the result of analysis on the Braille data, Braille positional data is generated for each of the Braille dots specified in the 2.5-dimensional data. The Braille positional data is herein generated such that the center position of a Braille dot is expressed as (x,y) coordinate data in the unit of mm. Braille size data may be a predetermined size defined in advance. Alternatively, Braille size may be set based on the size described in the received Braille data, which is 2.5-dimensional data, or in data associated therewith. Note that Braille size is expressed by its diameter. Also, the following describes a specific example of forming a Braille dot indicated by positional information obtained as a result of the analysis by the Braille data analysis unit 701, the positional information in this example indicating a center position of (100 mm, 150 mm) and a diameter of 1.45 mm.

Using information obtained as results of the analysis by the Braille data analysis unit 701, or specifically data on Braille center position and size, the Braille data resolution conversion unit 702 converts the Braille data into pixel data on a group of pixels formed by a plurality of pixels corresponding to the Braille dot. Note that the Braille data is converted to pixel data on a group of pixels having a resolution of 1200 dpi, which is the print resolution of the printhead 102 in FIGS. 3A and 3B.

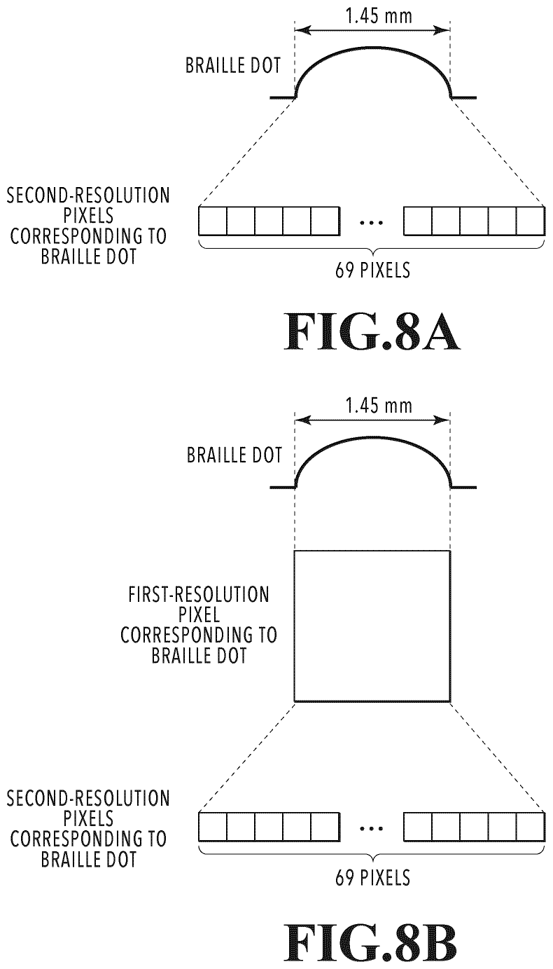

FIGS. 8A and 8B are diagrams illustrating processing executed by the Braille data resolution conversion unit 702. First, a description is given using FIG. 8A.

The center pixel is found based on the Braille center position (100 mm, 150 mm). First, the center in terms of the x-direction corresponds to the 4724-th pixel (=100 mm-25.4 mm×1200 dpi), after being rounded off to the closest whole number. Then, the center in terms of the y-direction corresponds to the 7087-th pixel (=150 mm-25.4 mm×1200 dpi), after being rounded off to the closest whole number. Thus, in this example, the center pixel is expressed as (4724, 7087).

Next, a pixel count along the diameter of the Braille dot region (circular region) is calculated. In the present disclosure, in order to facilitate calculation of a group of pixels corresponding to a Braille dot with respect to the position of the center pixel, the pixel count along the diameter is calculated to be an odd number. Because a Braille dot is 1.45 mm in diameter, the pixel count is calculated to be 68.5 (=1.45 mm=25.4 mm×1200 dpi). Then, being an odd number closest to this value, 69 is found as the diameter. Then, a radius pixel count is calculated to be 34 pixels as follows: subtracting the center pixel from the 69 pixels, which is the diameter pixel count, and then halving the resultant 68 pixels.

Next, a group of pixels corresponding to the Braille dot is calculated. With a given pixel set to (i, j), a distance r between the given pixel and the center pixel (4724, 7087) is calculated. The distance r is calculated according to the following formula: the distance r=(|i−4724|²+|j−7087|²)^{1/2}. The answer is then rounded off to the closest whole number. In a case where the distance r≤the radius pixel count 34, the given pixel is determined as a pixel corresponding to the Braille dot having the center pixel (4724, 7087). In a case where the distance r>the radius pixel count 34, the given pixel is determined as not being a pixel corresponding to the Braille dot having the center pixel (4724, 7087).

According to the processing thus described, as shown in FIG. 8A, resolution of Braille data can be converted, and 2.5-dimensional data can be converted to pixel data. Also, resolution conversion may be performed also on a region outside of the Braille dot, and it is assumed herein that the resolution of the outside region is converted to 1200 dpi as well.

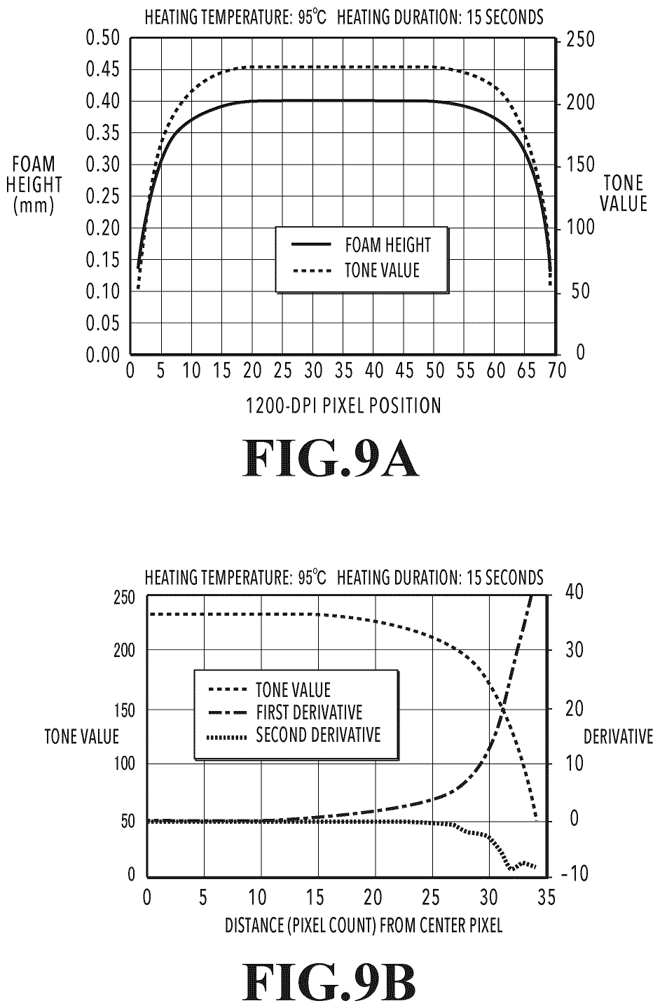

The Braille data pixel value adjustment unit 703 adjusts the pixel values (tone values) of the pixels in the group of pixels corresponding to the Braille dot after the resolution conversion by the Braille data resolution conversion unit 702. As described using FIG. 5, foam height can be controlled by the application amount of the foaming-promotion-component-containing ink. Using the relations shown in FIGS. 9A and 9B, the Braille data pixel value adjustment unit 703 adjusts the tone values of the resolution-converted group of pixels (69 pixels in the diameter direction) corresponding to the Braille dot shown in FIG. 8A and sets the tone values obtained by the adjustment.

FIG. 9A is a diagram showing, with a solid line, predetermined foam heights at the respective pixel positions of the 69 pixels in the diameter direction of a Braille dot. This relation indicated by the solid line is called a foam height table. FIG. 9A also shows, with a broken line, tone values for the respective pixel positions, or more specifically tone values corresponding to the application amounts of foaming-promotion-component-containing ink for achieving the predetermined foam heights. This relation indicated by the broken line is called a tone value table.

In FIG. 9A, the pixel at pixel position 35 is the center position. The predetermined foam heights satisfies JIS T0921 standards as shown in FIG. 6A and is such that, as indicated with the solid line in FIG. 9A, peripheral pixels of a Braille dot have lower foam heights than the center pixel of the Braille dot. Thus, the Braille dot based on the relation in FIG. 9A has a rounded protruding shape. Note that the “peripheral pixels of a Braille dot” herein are pixels in a region surrounding the center region including the center pixel of the Braille dot and may be referred to as “peripheral inner pixels” in the sense that they are included in the range of the Braille dot region (69 pixels) of the Braille dot (or are inside this range). Heating conditions for the case shown in FIG. 9A are the same as those for the case shown in FIG. 5. Thus, FIG. 9A shows the relation between foam heights and tone values in relation to pixel positions, under the following heating conditions: a heating temperature of 95° C. and a heating duration of 15 seconds. The adjustment of the pixel values of second-resolution pixels shown in FIG. 8A in this example may specifically mean setting of the tone values of the second-resolution pixels at the pixel positions according to the relation in FIG. 9A.

FIG. 9B is a graph showing, with a broken line, adjusted tone values of pixels in relation to the distance (pixel count) from the center pixel of the Braille dot. For each pixel in the group of pixels of the Braille dot, its tone value is adjusted according to its distance r from the center pixel, as indicated by the broken line in FIG. 9B. Also, in FIG. 9B, the dash line shows the first derivatives of tone values in the direction from the peripheral pixels to the center pixel of the Braille dot, and the dotted line shows the second derivatives of tone values in the direction from the peripheral pixels to the center pixel of the Braille dot.

To obtain a rounded protruding shape, a tone value needs to have a first derivative of 0 or larger and a second derivative of 0 or smaller in the direction from the peripheral pixels to the center pixel of the Braille dot. Also, as shown in FIG. 9A, the higher the tone value, the higher the foam height. Due to this relation, a rounded protruding shape can be said to be a shape such that the first derivative of foam height is 0 or larger and the second derivative of foam height is 0 or smaller in the direction from peripheral pixels to the center pixel of a Braille dot. Here, a “most marginal pixel” is a pixel included in pixels in second-resolution pixel data, i.e., a group of second-resolution pixels, and located at the most marginal portion of the range covering this group of pixels, and a “marginal pixel” refers to one or more pixels connecting with this most marginal pixel. The adjustment of tone values described using FIG. 9A is performed on a (peripheral) marginal region surrounding the center region, on one end portion. Specifically, the marginal region is a pixel region having, of the 69 pixels, three or more consecutive marginal pixels including the most marginal pixel. The adjustment of tone values is similarly performed on the other end portion as well. This achieves a rounded protruding shape by giving the following characteristics: the first derivative of a foam height is 0 or larger and the second derivative of the foam height is 0 or smaller in the direction from peripheral pixels to the center pixel of the Braille dot.

Note that in the mode described herein, the table shown in FIG. 9A holds, as height characteristics, a first relation as a correspondence relation between pixel position and foam height and a second relation as a correspondence relation between pixel position and tone value, and the second relation is used to adjust the tone values of pixels in a 2.5-dimensional region. However, the present disclosure is not limited to this mode as long as the table holds at least one of the first relation and the second relation, and the relation held by the table is used to derive final tone values. Note, however, that in a case of using the first relation held in the table, a step is needed to derive tone values based on foam heights corresponding to pixel positions.

FIG. 8B is a diagram showing how first-resolution pixels corresponding to a Braille dot are converted to a group of second-resolution pixels. The first-resolution pixel in FIG. 8B is obtained as an analysis result obtained by the Braille data analysis unit 701 (see FIG. 7) from Braille data received. Thus, while an EDEL expresses a Braille dot as a single black dot as described earlier, it can be said that the Braille data analysis unit 701 performs processing to associate a Braille dot with a first-resolution pixel in FIG. 8B. Note that the first resolution in this example is approximately 17.5 (=25.4 mm-1.45 mm) dpi because one pixel corresponds to the diameter of a Braille dot, which is 1.45 mm.

As shown in FIG. 8B, the Braille data resolution conversion unit 702 converts the first-resolution pixel into a group of second-resolution pixels. Because the second resolution is 1200 dpi in this example, there are 69 second-resolution pixels (=1200 dpi÷17.5 dpi), which is an odd number closest to the pixel count corresponding to 1.45 mm.

Whether a target pixel is a pixel in a group of second-resolution pixels corresponding to a Braille dot is determined based on whether its distance r from the center pixel of the second-resolution pixels≤a radius pixel count “34.”

Also, because the number of first-resolution pixels is 1 in this example, there is one tone value. Forming a Braille dot by setting this tone value to all the pixels in the group of second-resolution pixels does not result in the sectional shape shown in FIGS. 6A and 6B. Specifically, because all the second-resolution pixels have the same tone value, the same amount of foaming-promotion-component-containing ink is applied to the center pixel of the Braille dot and to the peripheral inner pixels of the Braille dot. As a result, the center pixel of the Braille dot and the peripheral inner pixels of the Braille dot will have the same foam height. Note that in a case where the foaming-promotion-component-containing ink applied to a region corresponding to one 1200-dpi pixel on a print medium having a foaming layer spreads beyond the region of one pixel, the foaming height may not be the same. Of the peripheral pixels of a Braille dot, the number of pixels neighboring the center pixel is more than the number of pixels neighboring a single most marginal pixel. Thus, the amount of foaming-promotion-component-containing ink applied to the most marginal pixel is smaller than that applied to the center pixel, resulting in lower foam height. Even in this case, the sectional shape does not turn out to be as shown in FIGS. 6A and 6B.

For this reason, using the relation in FIG. 9A, the Braille data pixel value adjustment unit 703 adjusts the tone values of the pixels in the group of second-resolution pixels corresponding to a Braille dot. The tone values are thus adjusted to make the center pixel of the Braille dot have a higher foam height than the peripheral pixels of the Braille dot, thereby achieving a rounded protruding shape.

The rounded protruding shape thus formed is the shape of a 2.5-dimensional image (more specifically a Braille image formed by a plurality of pixels) printed on one surface of a print medium. Thus, the processing described above using FIGS. 7 to 9B can be called 2.5-dimensional image data generation processing or pixel data generation processing. Also, the host PC 200 that executes the 2.5-dimensional image data generation processing can be called a 2.5-dimensional image data generation apparatus or a pixel data generation apparatus.

The relationship between predetermined foam heights and tone values for controlling foam height to the predetermined foam heights (tone values corresponding to the predetermined foam heights) to the pixel positions, which is used for achieving a rounded protruding shape, is not limited to the one shown in FIGS. 9A and 9B. Different countries have different Braille sizes and interspaces. Thus, a preferable predetermined foam height at each pixel position and a tone value corresponding to the foam height differ depending on the country. Thus, a plurality of patterns (corresponding to a plurality of countries) of the relation between predetermined foam heights and pixel positions or the relation between tone values corresponding to the foam heights and pixel positions are stored (registered) beforehand, so that an applicable pattern can be selected from these patterns. Then, the Braille data pixel value adjustment unit 703 can select a suitable pattern for the target country and therefore support various Braille standards that differ from one country to another, with high precision.

The patterns may be of the relationship between predetermined tone values corresponding to predetermined foam heights and pixel positions as described above or of a different relationship. For example, the relationship between predetermined foam heights and pixel positions (a first relationship) is registered beforehand for each of a plurality of countries, and the relationship between tone values and the predetermined foam heights is separately held. In this case, a predetermined foam height is determined based on the pixel position, and a tone value is determined based on the predetermined foam height using the second relationship.

Also, for example, the relationship between differences of predetermined foam heights from a particular reference foam height and pixel positions (a first relationship) is registered beforehand for each of a plurality of countries, and a relationship indicating tone values corresponding to the predetermined foam heights is separately held. In this case, the difference of a predetermined foam height is determined based on a pixel position, and the difference is added to the particular reference foam height to determine a predetermined foam height. Then, using the second relationship, a tone value is determined based on the predetermined foam height thus determined.

In the embodiment described above, a plurality of patterns of the relationship between tone values corresponding to predetermined foam heights and pixel positions are registered in advance as height characteristics, and a pattern is selected from the plurality of patterns. Alternatively, a single pattern may be registered in advance. Also, a new pattern registration function may be provided in order to support situations such as update of Braille standards, addition of a new Braille standard, and absence of predetermined height characteristics in the plurality of patterns. In other words, a function may be provided to store new height characteristics as new pattern registration. Desired height characteristics may be generated and registered as follows: adding the generated height characteristics as new height characteristics, saving the generated height characteristics by overwriting the already-registered height characteristics, or saving the generated height characteristics by replacing the already-registered height characteristics. The registration may be performed by a user or a serviceman.

<Image Processing Executed in Printing a Color Image with the IJ Printer>

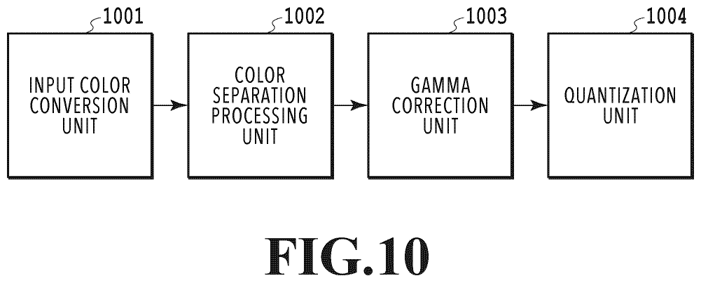

FIG. 10 is a functional block diagram illustrating image processing executed by the printing apparatus 100 according to the present disclosure in printing a color image. The image processing is executed by an input color conversion unit 1001, a color separation processing unit 1002, a gamma correction unit 1003, and a quantization unit 1004.

The input color conversion unit 1001, the color separation processing unit 1002, the gamma correction unit 1003, and the quantization unit 1004 are implemented by the printing apparatus 100. Specifically, the CPU 211 of the printing apparatus 100 functions as the input color conversion unit 1001, the color separation processing unit 1002, the gamma correction unit 1003, and the quantization unit 1004. Specifically, the CPU 211 implements the input color conversion unit 1001, the color separation processing unit 1002, the gamma correction unit 1003, and the quantization unit 1004 by loading programs stored in the HDD (not shown in FIG. 2) or the ROM 213 to the RAM 212 and executing them.

Data received by the input color conversion unit 1001 has a resolution of 1200 dpi and is multi-value data (RGB data) where each pixel has pixel values for three channels, R, G, and B (each pixel value is a multi-value and is eight-bit long in this example). The input color conversion unit 1001 obtains multi-value data (8 bits) by converting the RGB data so that it is expressed within a color reproduction region supported by the printing apparatus 100. The multi-value data obtained by the data conversion on the RGB data is referred to as R′G′B′ data. Note that data conversion is performed using a known method such as matrix computation processing or three-dimensional lookup table (3D-LUT) processing. A 3D-LUT is a table holding combinations of inputted RGB data and converted R′G′B′ data. For example, in a case where a 3D-LUT expresses each of R, G, and B colors using 16 stages, namely 0, 17, 34, . . . , 221, 238, and 255, out of the values 0 to 255, the 3D-LUT has 16×16×16=4096 combinations. In a case where RGB data coinciding with any of the combinations in the table is inputted, R′G′B′ data associated therewith in the table is outputted. Otherwise, R′G′B′ data is derived (calculated) based on tetrahedral interpolation computations using four close combinations and is outputted.

The color separation processing unit 1002 separates the R′G′B′ data into data in CMYK colors, which are colors used in the printing apparatus 100, and thereby obtains CMYK multi-value data (8 bits). This multi-value data is referred to as CMYK data. Data conversion from the R′G′B′ data to the CMYK data is performed using a known method such as matrix computation processing or 3D-LUT processing.

The gamma correction unit 1003 performs gamma correction on the CMYK data. Specifically, the gamma correction unit 1003 obtains multi-value data (12 bits) by correcting CMYK data so that the brightness of the image printed by the printing apparatus 100 onto the print medium 112 may change linearly. The multi-value data obtained by the gamma correction on CMYK data is referred to as C′M′Y′K′ data. Also, the gamma correction is performed using a one-dimensional lookup table (1D-LUT).

The quantization unit 1004 performs quantization on the C′M′Y′K′ data. Data obtained by this quantization is referred to as quantized data. The quantization is performed using a known method such as the dither method or the error diffusion method. In the present disclosure, quantized data is specifically such that each of the inks C, M, Y, and K on each 1200-dpi pixel is quantized as two-bit data, namely one of four values (0, 1, 2, or 3). In quantized data on each color, a pixel value “0” indicates that ink is not ejected, “1” indicates that ink is ejected once, “2” indicates that ink is ejected twice, and “3” indicates that ink is ejected three times.

Note that, as will be described later, data generated by the Braille data pixel value adjustment unit 703 (see FIG. 7) is also quantized by the quantization unit 1004 such that each pixel at 1200 dpi is quantized as two-bit data, namely, one of four values. The correspondence relationship between a value in quantized data and the number of times ink is ejected is the same as that for the color inks.

### First Embodiment

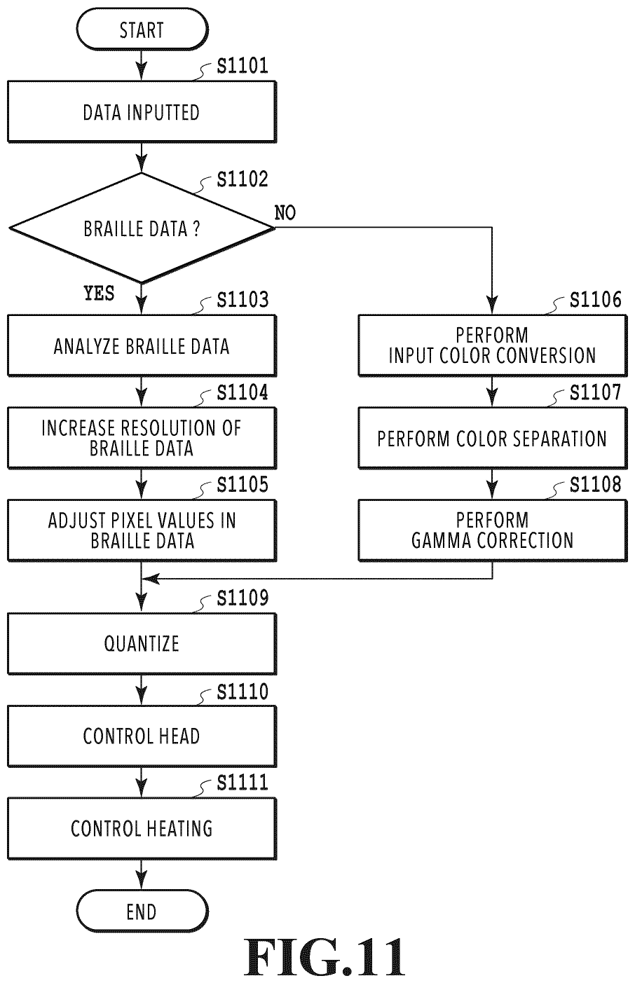

FIG. 11 is a flowchart of processing according to a first embodiment. Note that the foaming control component in the F ink used in the printing apparatus 100 according to the present embodiment is the foaming promotion component described above.

Processing in each step of the flowchart in FIG. 11 is executed by the printing system (see FIG. 2). In a case where processing in each step is executed on the host PC 200 side, the CPU 201 executes the processing by loading program code stored in the HDD 203 (or the ROM) into the RAM 202 and executing the program code. In a case where processing in each step is executed not by the host PC 200 but by the printing apparatus 100, the CPU 211 executes the processing by loading program code stored in the ROM 213 (or the HDD) into the RAM 202 and executing the program code.

In Step S1101, either Braille data generated by a Braille editor or color image data representing a color image to output is inputted to the host PC 200, and the CPU 201 of the host PC 200 obtains the data thus inputted. For brevity, “Step SXXX” is abbreviated as “SXXX” hereinbelow.

In S1102, the CPU 201 determines whether the data inputted in S1101 is Braille data. The determination as to whether the inputted data is Braille data is made by, for example, determining whether the file format is a file format outputted by Braille editors, such as BES. If the determination result in this step is YES, the processing proceeds to S1103. If the determination result in this step is NO (i.e., the inputted data is RGB color image data), the processing proceeds to S1106. In this case, before S1106 in which color conversion processing is performed on the color image data, the resolution of the RGB color image data is converted to 1200 dpi in this example unless it is already 1200 dpi. This resolution conversion is performed using a known resizing method such as nearest neighbor, bilinear, or bicubic.

In S1103, the CPU 201 functioning as the Braille data analysis unit 701 (see FIG. 7) analyzes the Braille data, which is 2.5-dimensional data. As a result of the analysis in this step, center position data and the diameter data are generated or obtained as positional information on each Braille dot.

In S1104, the CPU 201 functioning as the Braille data resolution conversion unit 702 (see FIG. 7) increases the resolution of the Braille data. Specifically, using the center position data and the diameter data obtained in S1103, processing is performed to convert a pixel corresponding to a Braille dot at a first resolution into a group of pixels at a second resolution higher than the first resolution. This processing is executed on every Braille dot. Note that in the present embodiment, the second resolution is 1200 dpi, and the resolution conversion is executed using the method described earlier using FIGS. 8A and 8B. In other words, in S1105, each Braille dot is represented by a plurality of pixels at the second resolution, which is higher than the first resolution for a foam region corresponding to the Braille dot, and pixel data is recognized as a group of pixels forming the foam region. Thus, the Braille data resolution conversion unit 702 can also be called an pixel data recognition unit.

In S1105, the CPU 201 functioning as the Braille data pixel value adjustment unit 703 (see FIG. 7) adjusts tone values of the respective pixels in the data on the group of second-resolution pixels corresponding to the Braille dot and sets the adjusted tone values to the respective pixels. The adjustment of tone values is executed using the method described using FIGS. 9A and 9B. With this method, tone values are adjusted so that peripheral inner pixels (or more specifically marginal pixels) of the Braille dot may have smaller tone values than the center pixel of the Braille dot, so that a rounded protruding shape may be formed. Because tone values are determined by this adjustment, the Braille data pixel value adjustment unit 703 may also be called as a Braille data determination unit. Also, because tone values are adjusted to 8-bit values in the tone value adjustment using FIGS. 9A and 9B, the tone values are converted 12-bit values to be ready for the subsequent quantization (S1109). In other words, an 8-bit numerical value is multiplied by 16 and thus converted to a 12-bit numerical value. Note that in the present embodiment, tone values of pixels outside of a Braille dot are fixed at 0, which is the minimum value. The purpose for this is to not apply the foaming promotion component to pixels outside of the Braille dot in order to minimize foaming there. After this step, the CPU 201 outputs the data obtained by S1105 to the printing apparatus 100 via the data transfer I/F 204.

In S1106, the CPU 211 functioning as the input color conversion unit 1001 (see FIG. 10) converts the 8-bit RGB data into 8-bit R′G′B′ data.

In S1107, the CPU 211 functioning as the color separation processing unit 1002 (see FIG. 10) converts the 8-bit R′G′B′ data into 8-bit CMYK data.

In S1108, the CPU 211 functioning as the gamma correction unit 1003 (see FIG. 10) performs gamma correction on the CMYK data. Specifically, the 8-bit CMYK data is converted into 12-bit C′M′Y′K′ data.

In S1109, the CPU 211 functioning as the quantization unit 1004 (see FIG. 10) performs quantization. Quantization performed in this step is described in detail below.

In an example scenario, Braille data is inputted in S1101, and the CPU 211 obtains 1200-dpi, 12-bit Braille data (a result of the S1105) before executing S1109. In this scenario, the CPU 211 quantizes the 1200-dpi, 12-bit Braille data into 2-bit, four-value quantized data for the Fink, which is a foaming-promotion-component-containing ink for controlling Braille foam height.

Also, in another example scenario, color image data is inputted in S1101, and the CPU 211 obtains 1200-dpi, 12-bit color image data (a result of the S1108) before executing S1109. In this scenario, the CPU 211 quantizes the 1200-dpi, 12-bit color image data into 2-bit, four-value quantized data for each of the CMYK inks.

In S1110, the CPU 211 performs head control to apply ink to the print medium 112 using the print unit 101 (see FIG. 1) based on the quantized data obtained in S1109. In the present embodiment, pixel values “0,” “1,” “2,” and “3” in quantized data respectively indicate zero shot of ink, one shot of ink, two shots of ink, and three shots of ink; thus, up to three shots of each ink are applied to each 1200-dpi pixel.

In S1111, the CPU 211 performs heating control using the heating unit 107 (see FIG. 1) to heat the print medium 112 having ink applied thereto. The heating in this step causes the print medium 112 to foam at regions to which the F ink has been applied, and as a result, heights according to the amounts of F ink applied are achieved as shown in FIG. 5. Meanwhile, the heating in this step causes the CMYK inks to be fixated onto the print medium 112.

As thus described, as data printable by the printing apparatus 100, the present embodiment can generate data for forming a rounded protruding shape where foam height is lower at a peripheral inner region of a Braille dot including peripheral inner pixels than at a center region including the center pixel of the Braille dot.

### Second Embodiment

In the first embodiment, a foaming promotion component is used as the F ink containing a foaming control component. In the present embodiment, a foaming suppression component is used as the F ink.

Japanese Patent Laid-Open No. 2019-155878 discloses using a foaming suppression component on a print medium containing foaming particles and using vinyl chloride resin as a foaming agent in a print medium. In heating (drying) of this print medium after the foaming suppression component is applied to the print medium, foaming of the foaming agent is suppressed at regions on the print medium to which the F ink containing the foaming suppression component has been applied, making it possible to lower the foam height. By contrast, not applying the foam suppression component can increase the foam height. In this way, the foam height can be controlled by the amount of foaming suppression component applied.

The print medium 112 used in the present embodiment is a print medium coated with vinyl chloride resin as a foaming agent. Also, as the F ink, an F ink containing a foaming suppression component that suppresses foaming of vinyl chloride resin is used. In regards to a specific F ink application method used by the printhead 102 to apply the F ink to the print medium 112, the method already described using FIGS. 1 to 3B is employed.

### <Processing in the Present Embodiment>

The processing executed in the present embodiment is roughly the same as that in the first embodiment (see FIG. 11). What is different is processing in S1105. This point is described in detail below.

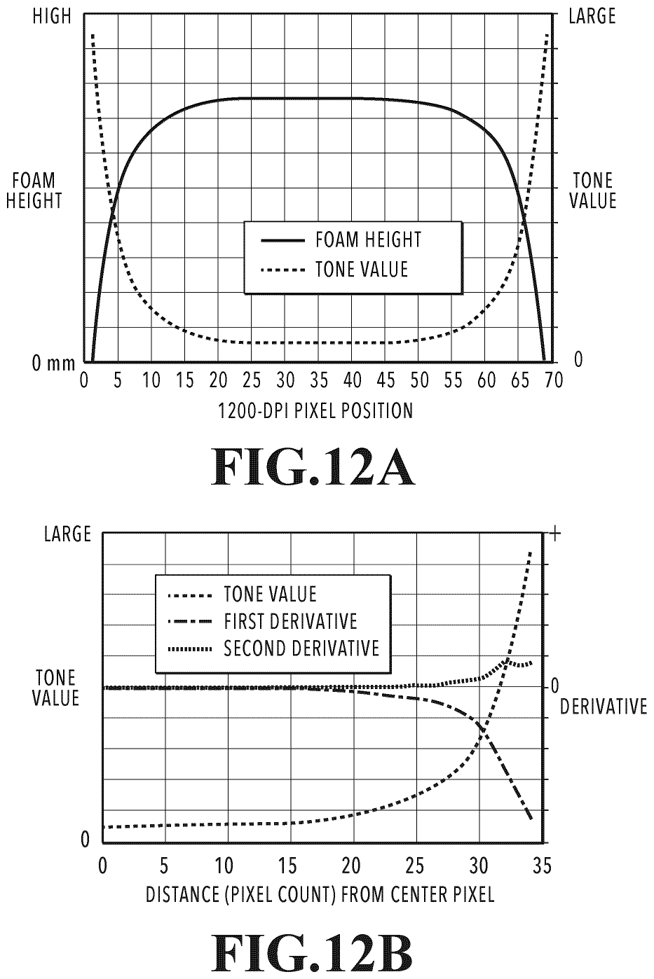

In the present embodiment, the Braille data pixel value adjustment unit 703 (see FIG. 7) adjusts and sets tone values of the pixels in the group of second-resolution pixels corresponding to a Braille dot. This tone value adjustment is performed using the relationships shown in FIGS. 12A and 12B. The present embodiment differs from the first embodiment in using the relationships in FIGS. 12A and 12B instead of those in FIGS. 9A and 9B.

FIG. 12A is a diagram showing the relationship between foam heights (solid line) on a print medium coated with vinyl chloride resin and the pixel positions of the 69 pixels in a diameter direction of a Braille dot and the relationship between pixel tone values (broken line) and those pixel positions. As shown in FIG. 12A, tone values are adjusted so that peripheral inner pixels of a Braille dot (specifically, the pixel at pixel position 1 and its neighboring pixels and the pixel at pixel position 69 and its neighboring pixels) may have larger tone values than the center pixel (the pixel at pixel position 35) of the Braille dot. Then, a rounded protruding shape is formed, where a peripheral inner region of the Braille dot including the peripheral inner pixels has lower foam height than a center region of the Braille dot including the center pixel.

FIG. 12B is a diagram showing, with a broken line, adjusted tone values of pixels in relationship to the distances (pixel count) from the center pixel of a Braille dot. The tone value of each pixel in the group of pixels forming the Braille dot is adjusted according to its distance r from the center pixel, as shown with the broken line in FIG. 12B. Also, the dash line and the dotted line in FIG. 12B show first derivatives and second derivatives, respectively, of the tone values in the direction from the peripheral pixels to the center pixel of the Braille dot.

To form a rounded protruding shape, a tone value needs to have a first derivative of 0 or smaller and a second derivative of 0 or larger in the direction from peripheral pixels to the center pixel of a Braille dot. Also, as shown in FIG. 12A, the lower the tone value, the higher the foam height. This relationship exhibits an opposite tendency from the foaming promotion component described in the first embodiment (see FIG. 9A). Thus, a rounded protruding shape can also be said to be a shape where the first derivative of foam height is 0 or smaller and the second derivative of foam height is 0 or larger in the direction from peripheral pixels to the center pixel of a Braille dot.

The tone values obtained by the adjustment in S1105 is converted to 12-bit values to be ready for the subsequent quantization (S1109). Note that in the present embodiment, tone values of pixels outside of a Braille dot are all set to a fixed maximum value. The purpose for this is to apply the foaming suppression component to pixels outside of a Braille dot in order to minimum foaming at the outside of the Braille dot.

As a result of the processing thus described, data for forming a rounded protruding shape can be generated where foam height is lower at a peripheral inner region of a Braille dot including peripheral inner pixels than at a center region including the center pixel of the Braille dot. In this way, even in a case where foam height on a print medium is controlled using not a foaming promotion component but a foaming suppression component, advantageous effects similar to those offered by the first embodiment can still be achieved.

Note that the relationship between predetermined foam heights and tone values for controlling foam height to the predetermined foam heights (tone values corresponding to the predetermined foam heights) in relationship to the pixel positions, which is used for achieving a rounded protruding shape using a foaming suppression component, is not limited to the one shown in FIGS. 12A and 12B. Different countries have different Braille sizes and interspaces. Thus, a preferable predetermined foam height and a tone value corresponding to the foam height at each pixel position differ depending on the country. Thus, a plurality of patterns (corresponding to a plurality of countries) of the relationship of predetermined foam heights and tone values corresponding to the foam heights in relationship to pixel positions are registered beforehand, so that an applicable pattern can be selected from these patterns. Then, a suitable pattern for the target country can be selected, supporting various Braille standards that differ from one country to another, with high precision. A single pattern may be selected and registered in advance. Also, a user or a serviceman may be allowed to add a pattern, replaces a pattern, or save a pattern by overwriting an existing one. This makes it possible to determine tone values using height characteristics different from the existing patterns.

### Third Embodiment

The first and second embodiments do not make particular reference to overlapping of a foam region and a region where a color ink is applied. The present embodiment describes processing performed in a case where these regions are overlapped.

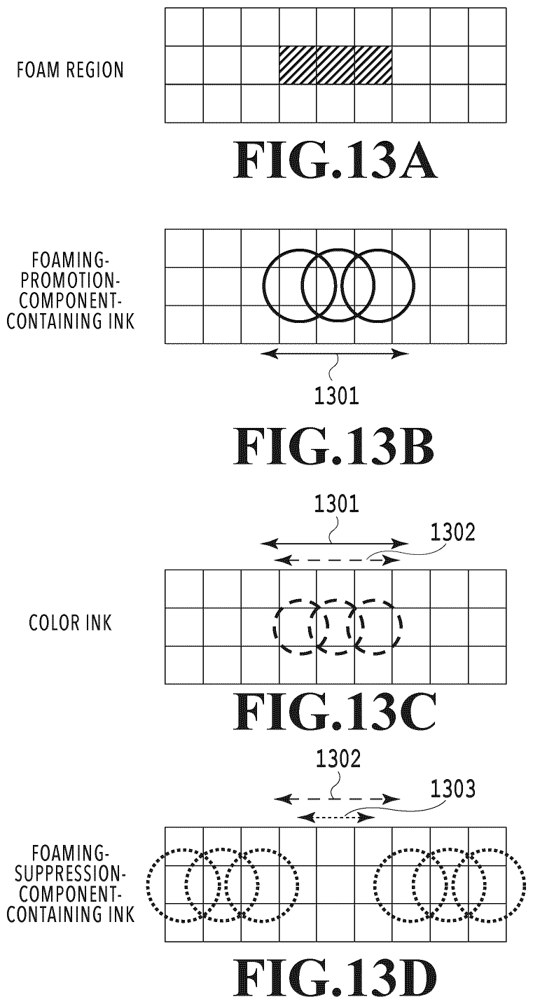

FIGS. 13A, 13B, 13C, and 13D are conceptual images showing how ink dots spread after ink is applied to pixels in a foam region and to pixels around the foam region on a print medium. The amount of ink applied per ink dot is the same as that in the embodiments described above. In FIGS. 13A to 13D, each of the 27 rectangles (each rectangle is the smallest unit) shows a pixel at the second resolution described above, and the 27 pixels in FIGS. 13A to 13D correspond to 27 pixels in the same region on a print medium.

In this example, a foam region is a three-pixel region hatched in FIG. 13A. In FIG. 13B, solid-line circles show how the ink dots spread once the foaming-promotion-component-containing ink is applied to foam the hatched three pixels, and a solid-line arrow 1301 shows the width of the spread. Also, in FIG. 13D, dotted-line circles show how the ink dots spread once the foaming-suppression-component-containing ink is applied to foam the hatched three pixels, and a dotted-line arrow 1303 shows the width of a region not reached by the spread of the ink dots. A color ink is applied to the hatched three pixels to overlap with the foam region. In FIG. 13C, broken-line circles show how ink dots of the color ink spread, and a broken-line arrow 1302 shows the width of this spread.

As shown in FIGS. 13B to 13D, the ink dots of foaming-promotion-component-containing ink and the ink dots of the foaming-suppression-component-containing ink spread more than the ink dots of the color ink. The foaming-promotion-component-containing ink and the foaming-suppression-component-containing ink need to act on the foaming agent in the print medium and therefore have higher permeability than the color ink in order to permeate into the print medium easily. Thus, a foaming-control-component-containing ink permeates into a print medium from the surface of the print medium, causing its ink dots to spread. By contrast, to reproduce a color well, a color ink has lower permeability than a foaming-control-component-containing ink to stay near the surface of a print medium. For this reason, an ink dot of a color ink spreads less than that of a foaming-control-component-containing ink.

In regard to the spread width relative to a foam region, as shown in FIGS. 13A to 13C, the width of the foaming-promotion-component-containing ink indicated by the arrow 1301 is larger than that of the color ink indicated by the arrow 1302. Thus, a region where a color ink is fixated has a narrower width than a foam region that actually foams under heating. Although a foam region has three pixels here to provide a simpler description, in a case where a foam region includes much more pixels, a region where a color ink is fixated still has a narrower width than the foam region that actually foams under heating. Thus, a colorless foam region exists around a color ink fixation region as if to rim the color ink fixation region. To decrease such a colorless rim, in the present embodiment, a less amount of foaming-promotion-component-containing ink is applied to a group of pixels which are inside of and at a marginal portion of a foam region.

One method for decreasing the application amount of foaming-promotion-component-containing ink is to reduce the tone values of the group of pixels at the marginal portion. With this method, as a result of the quantization performed after the reduction of the tone values, the number of shots for those pixels are decreased, thereby reducing the application amount of foaming-promotion-component-containing ink. A relationship as to tone values to make the rim less noticeable is found in advance by experiment, and a table holding this relationship is prepared in advance. Then, in the processing of Braille data, the tone values of the group of pixels at the marginal portion are adjusted to be smaller with reference to this table.

Another method for decreasing the application amount of foaming-promotion-component-containing ink is to, after quantization, probabilistically thin the number of shots from the group of pixels in the marginal portion. With this method, the number of shots for those pixels are decreased, thereby reducing the application amount of foaming-promotion-component-containing ink. How much to thin is determined with reference to a thinning probability table obtained in advance by experiment.

The processing thus described can be used to decrease a colorless foam region existing around a color ink fixation region.

Also, as shown in FIGS. 13A and 13D, the width of the foam region not affected by the foaming-suppression-component-containing ink, which is indicated by the arrow 1303, is smaller than the width of the color ink indicated by the arrow 1302. Thus, a color ink fixation region is wider than the foam region that actually foams under heating. Although a foam region has three pixels here to provide a simpler description, in a case where a foam region includes much more pixels, a color ink fixation region is still wider than the foam region that actually foams under heating. As a result, the color ink fixation region has a region with low foam height. Thus, in the present embodiment, to decrease the region with low foam height, a less amount of foaming-suppression-component-containing ink is applied to the group of pixels which are outside of a foam region and adjacent to the foam region.

One method to decrease the application amount of the foaming-suppression-component-containing ink is to reduce the tone values of the group of relevant pixels. With this method, as a result of the quantization performed after the reduction of the tone values, the number of shots for those pixels are decreased, thereby reducing the application amount of the foaming-suppression-component-containing ink. A relationship as to tone values to reduce the region with low foam height is found in advance by experiment, and a table holding this relationship is prepared in advance. Then, in the processing of Braille data, the tone values of the group of relevant pixels are adjusted to be smaller with reference to this table.

Another method for decreasing the application amount of ink containing a foaming suppression component is to, after quantization, probabilistically thin the number of shots from the group of relevant pixels. With this method, the number of shots for those pixels are decreased, thereby reducing the application amount of the foaming-suppression-component-containing ink. How much to thin is determined with reference to a thinning probability table obtained in advance by experiment.

The processing thus described can be used to decrease a region with low foam height in a color ink fixation region.

Also, in regard to the actual spread width compared to the spread width on foam region data (three pixels wide in this example), for example, in a case of the foaming-promotion-component-containing ink, the actual spread width is larger than the three-pixel width on data, as indicated by the arrow 1301 in FIG. 13B. Also, in a case of the foaming-suppression-component-containing ink, the actual spread width is smaller than the three-pixel width on data, as indicated by the arrow 1303 in FIG. 13D. In this way, even in a case where a color ink is not overlapped, a foam region in data and a foam region that actually foams differ from each other in terms of the region size. Thus, to reduce this difference, the application amount of the foaming-promotion-component-containing ink or the application amount of the foaming-suppression-component-containing ink may be reduced even in a case where they do not overlap with a color ink. With the foaming-promotion-component-containing ink, its application amount is reduced for pixels inside of and at a marginal portion of the foam region. With the foaming-suppression-component-containing ink, its application amount is reduced for pixels outside of a foam region and adjacent to the foam region. The difference in size between a foam region in data and a foam region that actually foams can thus be reduced.

### OTHER EMBODIMENTS

In the first and second embodiments, tone-value adjustment is made on the tone values of resolution-converted pixels inside a 2.5-dimensional image region, such as a Braille dot. Also, in the first embodiment that uses a foaming promotion component, the tone values of pixels outside of a 2.5-dimensional image region are set to the minimum value. Further, in the second embodiment that uses a foaming suppression component, the tone values of pixels outside of a 2.5-dimensional image region are set to the maximum value.

The tone values of pixels outside of a 2.5-dimensional image region are not limited to fixed values such as the minimum or maximum value as described above, and may be other values. For example, to have a given height at the outside of a 2.5-dimensional image region as well, a tone value may be controlled to achieve an application amount corresponding to the given height. However, because a 2.5-dimensional image region protrudes more upward than its outside, in a case of using a foaming promotion component, it is preferable that the tone value of a pixel outside a 2.5-dimensional image region be smaller than the tone value of a pixel in the image region. In a case of using a foaming suppression component, it is preferable that the tone value of a pixel outside a 2.5-dimensional image region be larger than the tone value of a pixel in the image region.

Also, in the first to third embodiments, the host PC 200 performs data processing on Braille data, and the printing apparatus 100 performs image processing on a color image. However, the present disclosure is not limited to this mode. The printing apparatus 100 may perform data processing on Braille data, and the host PC 200 may perform image processing on a color image. It does not matter which of the host PC 200 and the printing apparatus 100 implements the function modules described using FIGS. 7 to 10, as long as the printing apparatus 100 has the quantized data obtained in S1109 in FIG. 11. From such a perspective, the host PC 200 and the printing apparatus 100 according to the present disclosure may each be called a data generation apparatus configured to generate pixel data.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure can form Braille dots with a shape that can be read with less illegibility.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-090679, filed Jun. 4, 2024, which is hereby incorporated by reference wherein in its entirety.

What is claimed is:

1. A data generation apparatus that generates pixel data for printing a 2.5-dimensional image, the data generation apparatus comprising:
At least one memory storing a program; and
At least one processor that, upon execution of the stored program, is configured to operate as:
a conversion unit that converts 2.5-dimensional data having a first resolution to pixel data having a second resolution using position information on a 2.5-dimensional region obtained from the 2.5-dimensional data representing the 2.5-dimensional image; and
an adjustment unit that adjusts tone values of second-resolution pixels included in the 2.5-dimensional region represented in the pixel data by determining a tone value of a pixel in a center region including at least a center pixel and a tone value of a pixel in a marginal region which is inside of the 2.5-dimensional region and which surrounds the center region using information on height characteristics at pixel positions of the second-resolution pixels.

2. The data generation apparatus according to claim 1, wherein the at least one memory stores the information on the height characteristics which is a tone value table representing a correspondence relationship between the pixel positions of the second-resolution pixels and tone values associated with foam heights.

3. The data generation apparatus according to claim 2, wherein
a plurality of patterns are stored as the height characteristics, and
the adjustment unit selects and uses one of the plurality of patterns.

4. The data generation apparatus according to claim 3, wherein
the data generation apparatus has a registration function for registering a new pattern of the height characteristics.

5. The data generation apparatus according to claim 2, wherein
the second resolution is higher than the first resolution.

6. The data generation apparatus according to claim 5, wherein
as a result of the adjustment by the adjustment unit, the tone value of the pixel in the center region is turned into a first value corresponding to a predetermined first height, and the tone value of the pixel in the marginal region is turned into a second value corresponding to a second height lower than the first height.

7. The data generation apparatus according to claim 6, wherein
in a direction from a marginal portion to a center of the 2.5-dimensional region, a first derivative of the tone value is 0 or larger, and a second derivative of the tone value is 0 or smaller.

8. The data generation apparatus according to claim 6, wherein
in a direction from a marginal portion to a center of the 2.5-dimensional region, a first derivative of the tone value is 0 or smaller, and a second derivative of the tone value is 0 or larger.

9. The data generation apparatus according to claim 6, wherein
in a case where a number of the second-resolution pixels included in the 2.5-dimensional region is 69, the marginal region is a region with three or more successive marginal pixels including a most marginal pixel out of the second-resolution pixels.

10. The data generation apparatus according to claim 2, further comprising an output unit configured to output the pixel data obtained by the adjustment by the adjustment unit.

11. A printing apparatus that is in communication with a data generation apparatus according to claim 1, the printing apparatus comprising:
a printhead configured to print an image based on data received from the data generation apparatus onto a print medium having a foaming layer containing foaming particles that foam under heat, the printhead being configured to eject a color ink and a foaming-control-component-containing ink containing a foaming control component that controls foamability of the foaming particles;
a heating unit configured to heat the print medium on which the image has been printed by the printhead; and
a control unit.

12. The printing apparatus according to claim 11, wherein
the foaming-control-component-containing ink is a foaming-promotion-component-containing ink containing a foaming promotion component that promotes foamability of the foaming particles.

13. The printing apparatus according to claim 12, wherein
the data received from the data generation apparatus includes an adjusted tone value of a pixel outside the 2.5-dimensional region that has been adjusted to a value smaller than a tone value of a pixel inside the 2.5-dimensional region.

14. The printing apparatus according to claim 13, wherein
the data received from the data generation apparatus includes the tone value of the pixel outside the 2.5-dimensional region set to a fixed minimum value.

15. The printing apparatus according to claim 14, wherein
in a case where the color ink is applied to a foam region which foams upon application of the foaming-promotion-component-containing ink, the control unit reduces an amount of the foaming-promotion-component-containing ink applied to a group of pixels inside of and at a marginal portion of the foam region.

16. The printing apparatus according to claim 11, wherein
the foaming-control-component-containing ink is a foaming-suppression-component-containing ink containing a foaming suppression component that suppresses foamability of the foaming particles.

17. The printing apparatus according to claim 16, wherein
the data received from the data generation apparatus includes an adjusted tone value of a pixel outside the 2.5-dimensional region that is adjusted to a value larger than a tone value of a pixel inside the 2.5-dimensional region.

18. The printing apparatus according to claim 17, wherein
the data received from the data generation apparatus includes the tone value of the second-resolution pixel outside the 2.5-dimensional region set to a fixed maximum value.

19. The printing apparatus according to claim 18, wherein
in a case where the color ink is applied to a foam region which foams upon application of the foaming-suppression-component-containing ink, the control unit reduces an amount of the foaming-suppression-component-containing ink applied to a group of pixels adjacent to the foam region.

20. The printing apparatus according to claim 11, wherein
a cross-sectional shape of the 2.5-dimensional image printed by the printhead is a rounded protruding shape.

21. The printing apparatus according to claim 20, wherein
the 2.5-dimensional image is a Braille image.

22. A method for controlling a data generation apparatus that generates pixel data for printing a 2.5-dimensional image, the method comprising:
converting the 2.5-dimensional data having a first resolution to pixel data having a second resolution by use of position information on a 2.5-dimensional region obtained from 2.5-dimensional data representing the 2.5-dimensional image; and
adjusting tone values of second-resolution pixels included in the 2.5-dimensional region represented in the pixel data by determining a tone value of a pixel in a center region including at least a center pixel and a tone value of a pixel in a marginal region which is inside of the 2.5-dimensional region and which surrounds the center region using information on height characteristics at pixel positions of the second-resolution pixels.

23. A non-transitory computer readable storage medium storing a program for causing a computer to execute a method for controlling a data generation apparatus that generates pixel data for printing a 2.5-dimensional image, the method comprising:
converting the 2.5-dimensional data having a first resolution to pixel data having a second resolution by use of position information on a 2.5-dimensional region obtained from 2.5-dimensional data representing the 2.5-dimensional image; and
adjusting tone values of second-resolution pixels included in the 2.5-dimensional region represented in the pixel data by determining a tone value of a pixel in a center region including at least a center pixel and a tone value of a pixel in a marginal region which is inside of the 2.5-dimensional region and which surrounds the center region using information on height characteristics at pixel positions of the second-resolution pixels.
